(19) United States
(12) Patent Application Publication
(10) Pub. No.: US 2008/0254658 A1
(43) Pub. Date: Oct. 16, 2008

(54) Memory card connector

(76) Inventors: Chin-chou Wang, Tu-Cheng City (TW); Yun-chien Lee, Tu-Cheng City (TW); Mei-chuan Yang, Tu-Cheng City (TW); Chung-hsin Huang, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/783,906

(22) Filed: Apr. 13, 2007

(51) Int. Cl. H01R 11/20

(52) U.S. Cl. 439/159

(57) ABSTRACT

A memory card connector includes a housing, a plurality of terminals and a cover. The housing consists of a bottom wall, a front wall, a back wall and a pair of side walls and defines a plurality of slots therein. A receptacle is formed among the walls. The terminals are received in the corresponding slots. The cover is pivotally mounted to the housing, having a top member. At least one pressed component is arranged on the top member. The pressed component includes a pair of opposite spring arms, one end of the spring arms connects with the top member, and the other is stamped individually to form a pair of inclined arms on the top member. The inclined arms joint together by a protruding joint portion, which presses down a memory card. Therefore, a firmly electrical connection between the memory card and the terminals is established.

### BACKGROUND OF THE INVENTION

1. Field of the Invention

The present invention relates to a connector, and more particularly to a memory card connector which can realize a firm electrical connection.

2. The Related Art

With the progress of technology, various portable digital devices are coming into our life continually. The portable digital device commonly stores data by a memory card. Correspondingly, a memory card connector is needed to set a memory card in the portable digital device firmly.

A conventional memory card connector includes a housing, a plurality of terminals mounted in the housing and a cover pivotally mounted to the housing. The housing has a bottom wall. The bottom wall extends upwardly from edges to form a front wall, a back wall, and a pair of side walls. Then a receptacle for receiving a memory card is provided by the bottom wall, the front wall, the back wall and the pair of side walls. The terminals are mounted in corresponding slots defined in the bottom wall. An end of the terminal protrudes upwardly into the receptacle to form a conductive contact portion for electrically connecting with the memory card.

However, sometimes, the memory card may be a little thin for being pressed down by a top member of the cover, so the memory card can not realize a firm electrical connection with the conductive contact portion of the terminal. Therefore, a new-designed plan for the memory card connector to overcome the deficiency is required.

### SUMMARY OF THE INVENTION

Accordingly, an object of the present invention is to provide a memory card connector in order to realize a firm electrical connection. The memory card connector includes a housing, a plurality of terminals and a cover. The housing has a bottom wall, which extends upwardly from edges to form a front wall, a back wall, and a pair of side walls, and defines a plurality of slots therein. A receptacle is formed among the walls. The terminals are received in the corresponding slots. The cover is pivotally mounted to the housing, having a top member. At least one pressed component is arranged on the top member. The pressed component includes a pair of opposite spring arms, one end of the spring arms connects with the top member, the other is stamped individually to form a pair of inclined arms on the top member. The inclined arms joint together by a protruding joint portion, which presses down a memory card. Therefore, a firmly electrical connection between the memory card and the terminals is established.

As described above, the pressed component of the cover presses down the memory card connector by the protruding joint portion. Therefore, a firm electrical connection between the memory card and the terminals is established.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a memory card connector with a cover in open status according to the present invention;

FIG. 2 is a perspective view of the memory card connector with the cover removed according to the present invention;

FIG. 3 is a perspective view of the cover according to the present invention;

FIG. 4 is a plan view showing a Micro SD card being received in the memory card connector with the cover removed;

FIG. 5 is a plan view of showing a MMC Micro card being received in the memory card connector with the cover removed;

FIG. 6 is a perspective view showing the Micro SD being received in the complete memory card connector and pressed by pressed components of the cover.

### DETAILED DESCRIPTION OF THE PREFERRED EMBODIMENT

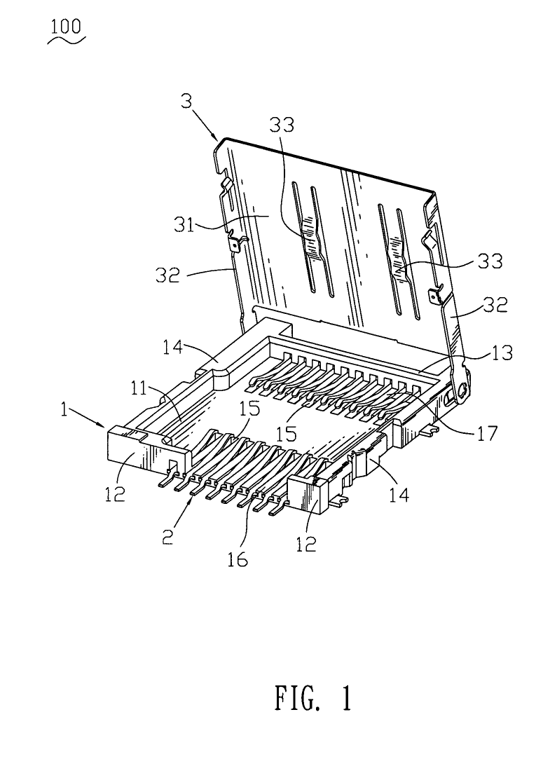

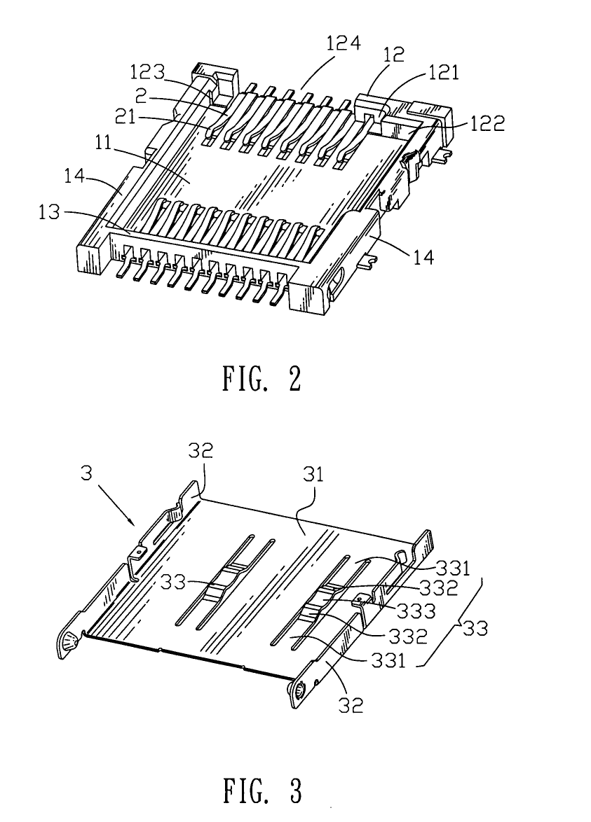

As shown in FIGS. 1 and 2, the invention is embodied in a memory card connector 100. The memory card connector 100 includes a housing 1, a plurality of terminals 2 mounted in the housing 1 and a cover 3 pivotally mounted to the housing 1. The housing 1 has a bottom wall 11. The bottom wall 11 extends upwardly from its front and back ends individually to form a front wall 12 and a back wall 13. Also the bottom wall 11 extends upwardly from its both sides individually to form a pair of side walls 14. Then a receptacle 10 for receiving a memory card is provided by the bottom wall 11, the front wall 12, the back wall 13 and the pair of side walls 14. The terminals 2 are mounted in corresponding slots 15 in two arrays which are located on the front and rear of the bottom wall 11. One end of the terminal 2 protrudes upwardly into the receptacle 10 as an arc conductive contact portion 21, and the other end of the terminal 2 extends out of the housing 1 and electrically connects to a printed circuit board (not shown).

Referring to FIGS. 2, 4 and 5, a part of inner surface of the front wall 12 is concaved to form a first fixing groove 121, and then a first obstructing face 122 and a second obstructing face 123 are formed at both sides of the first fixing groove 121. In addition, a part of inner surface of one side wall 14 is concaved to form a second fixing groove 141.

Referring to FIG. 3, the cover 3 is made of the sheet metal material by the way of stamping, certainly it can also be made by other materials and methods. The cover 3 is pivotally mounted at the back end of the housing 1, which includes a top member 31 and a pair of side arms 32 extending downwardly from both sides of the top member 31. There are two pressed components 33 arranged on the top member 31 side by side. The pressed component 33 includes a pair of opposite spring arms 331. One end of the spring arms 331 connects with the top member 31, the other is stamped individually to form a pair of inclined arms 332 on the top member 31. The inclined arms 332 joint together by a protruding joint portion 333, which provides an elastic force for pressing down the memory card and making the electrical connection firmly. So each pressed component 33 consists of a pair of spring arms 331, a pair of inclined arms 332 and a joint portion 333.

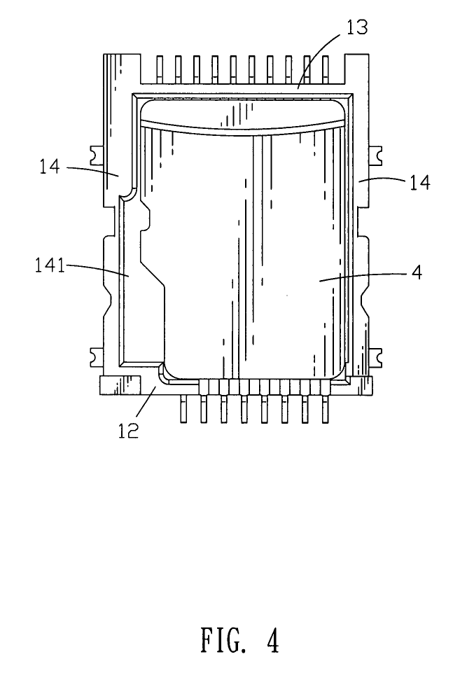

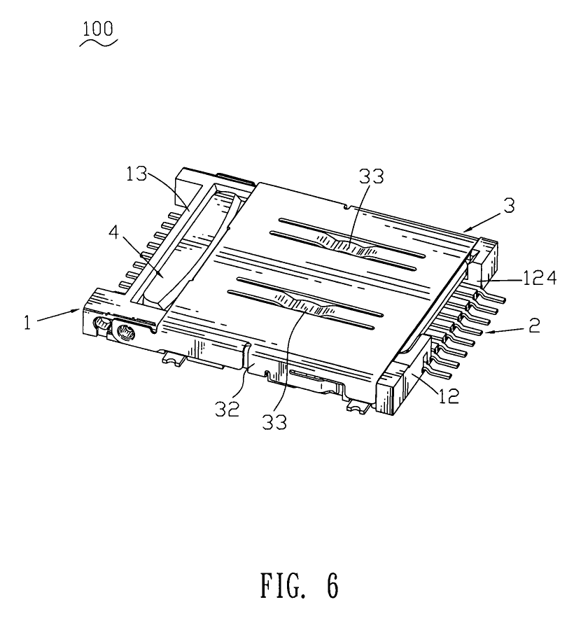

Referring to FIGS. 4 and 6, the memory card connector 100 is designed to receive a first memory card 4 and a second memory card 5 respectively by its receptacle 10. The first and second memory cards 4, 5 are two different memory cards, the sizes of which are a little different. The thickness of the first memory card 4 is less than the second memory card 5, so that the height of the first memory card 4 is lower than the housing 1 when being received in the receptacle 10 of the housing 1. In the case, the first memory card 4 is a Micro SD card. In assembly, the back end of Micro SD card is restricted by the back wall 13 and the front end of Micro SD card is locked in the first fixing groove 121, so that the Micro SD card 4 is fixed in the memory card connector 100. Then the cover 3 in open status is pivotally rotated and latched on the housing 1. The two pressed components 33 of the cover 3 protrude down into the receptacle 10 of the housing 1 and then press down the Micro SD card by the protruding joint portion 333. Therefore, a firm electrical connection between the Micro SD card and the terminals 2 is established.

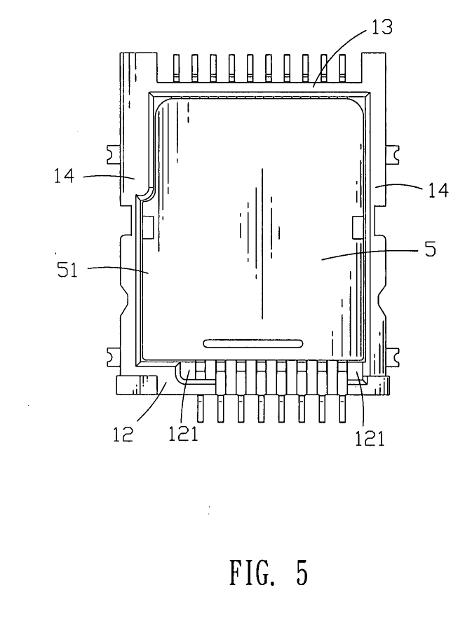

Referring to FIGS. 5 and 6, in the case, the second memory card 5 is a MMC Micro card. When the MMC Micro card is put into the receptacle 10 of the housing 1, the back end of the MMC Micro card is restricted by the back wall 13, the front end of the MMC Micro card is restricted by the first obstructing face 122 and the second obstructing face 123. Moreover, both sides of the MMC Micro card are blocked by the pair of side walls 14 of the housing 1. In addition, the second fixing groove 141 conforms to a projecting portion 51 of the MMC Micro card. So the MMC Micro card is fixed in the memory card connector. Afterward, the cover 3 in open status is pivoted and latched on the housing 1. The two pressed components 33 of the cover 3 press down the MMC Micro card by the protruding joint portion 333. Therefore, a firm electrical connection between the MMC Micro card and the terminals 2 is established.

As described above, the pressed component of the cover presses down the memory card connector by the protruding joint portion. Therefore, a firmly electrical connection between the memory card and the terminals is established.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

1. A memory card connector comprising:
a housing having a bottom wall, said bottom wall extending upwardly from edges to form a front wall, a back wall, and a pair of side walls, and defining a plurality of slots therein, a receptacle formed among said walls;
a plurality of terminals received in the corresponding slots; and
a cover pivotally mounted to the housing, wherein the cover has a top member, a pair of pressed component a being located on the top member, each of the pair of pressed components positioned substantially equidistant from a center line of the cover and formed in a central section of the cover, the pressed components including a pair of opposite spring arms, one end of the spring arms connecting with the top member, the other end of the spring arms being stamped individually to form a pair of inclined arms on the top member, the inclined arms jointing together by a protruding joint portion, which presses down a memory card.

2. The memory card connector as claimed in claim 1, wherein the top member has two parallel pressed components arranged longitudinally.

3. The memory card connector as claimed in claim 1, wherein the memory card connector is used to receive a first memory card and a second memory card which are different with each other, the thickness of the first memory card being less than the second memory card, so that the height of the first memory card lower than the housing when being received in the receptacle of the housing.

4. The memory card connector as claimed in claim 1, wherein the slots are in two arrays located on the front and rear of the bottom wall for corresponding to the first memory card and the second memory card respectively.

5. The memory card connector as claimed in claim 1, wherein a part of inner surface of the front wall is concaved to form a first fixing groove for locking a Micro SD card as the first memory card, and then a first obstructing face and a second obstructing face for restricting a MMC Micro card as the second memory card are formed at both sides of the first fixing groove, a part of inner surface of one side wall is concaved to form a second fixing groove for conforming to a projecting portion of the MMC Micro card.
